(19) United States
(12) Patent Application Publication
(10) Pub. No.: US 2016/0001837 A1
(43) Pub. Date: Jan. 7, 2016

(54) BAR SIGNAL LIGHT STRUCTURE

(71) Applicant: YI-CHUNG WAN, New Taipei City (TW)

(72) Inventor: YI-CHUNG WAN, New Taipei City (TW)

(21) Appl. No.: 14/320,991

(22) Filed: Jul. 1, 2014

(51) Int. Cl. B62J 6/00; F21V 23/06

(52) U.S. Cl. CPC B62J 6/005; F21V 23/06; B62J 6/003; F21Y 2101/02

(57) ABSTRACT

A bar signal light structure mainly includes a base body and a bar connected to the base body. Inside the base body is disposed a lamp holder which may slide along the base body. On the lamp holder is disposed a control circuit. To one side of the control circuit is electrically connected a light-emitting component. To another side of the control circuit is electrically connected a button holding against the back edge of the base body and a USB plug protruding from the back edge of the base body. The bar caps a handle of a bicycle. Before turning left or right while riding a bicycle, a user may press the lamp holder to press the button, which activates the control circuit to cause the light-emitting component to flash as a warning to enhance road safety. When not in use, the base body may be disassembled from the bar and plugged to a computer or a battery charger for recharging.

### BACKGROUND OF THE INVENTION

1. Field of the Invention

The present invention relates to a bar signal light structure, particularly to a bar signal light structure which flashes as a warning of a right or left turn when pressed to enhance road safety, and which may be plugged to a computer or a battery charger for recharging when not in use.

2. Description of Related Art

With the promotion of energy conservation and emissions reductions in recent years, bicycle riding has become more and more popular. Signal lights are prerequisite for cars and motorcycles. When making a turn, one of the signal lights is turned on and flashes as a warning to vehicles behind to prevent colliding. With the popularization of bicycle riding, it has been advocated that lights should also be installed on bicycles for safety's concern. But unlike cars or motorcycles, existing bicycles do not have signal lights installed on them. The light installed at the back of a bicycle may only serve as a warning without indicating a right or left turn. In view of this, after laborious research and experiments, the applicant has devised a bar signal light structure to enhance road safety of bicycles.

### SUMMARY OF THE INVENTION

It is an object of the present invention to provide a bar signal light structure, which flashes as a warning of a right or left turn when pressed to enhance road safety, and which may be plugged to a computer or a battery charger for recharging when not in use.

The foregoing bar signal light structure includes a base body and a bar connected to the base body. Inside the base body is disposed a lamp holder which may slide along the base body. On the lamp holder is disposed a control circuit. To one side of the control circuit is electrically connected a light-emitting component. To another side of the control circuit is electrically connected a button holding against the back edge of the base body and a USB plug protruding from the back edge of the base body. The bar caps a handle of a bicycle. Before turning left or right while riding a bicycle, a user may press the lamp holder to press the button, which activates the control circuit to cause the light-emitting component to flash as a warning to enhance road safety. When not in use, the bar signal light structure may be plugged to a computer or a battery charger for recharging

The foregoing bar signal light structure, wherein the light-emitting component is a high-brightness light emitting diode.

The foregoing bar signal light structure, wherein a mating part is disposed on the inner edge of the base body's wall surface and an engagement part on the outer edge of the lamp holder's wall surface so that when connected to the base body the lamp holder may slide along the base body with the engagement and mating parts stopping it and limiting its position.

### BRIEF DESCRIPTION OF THE DRAWINGS

FIG. 1 is a pictorial breakdown drawing of the present invention;

FIG. 2 is a cross-sectional view of the present invention;

FIG. 3 is a view of the present invention when capping a handle of a bicycle;

FIG. 4 is a view of the present invention in use;

FIG. 5 is a view of the present invention when activated;

FIG. 6 is a pictorial drawing of another preferred embodiment of the present invention;

### DETAILED DESCRIPTION OF THE PREFERRED EMBODIMENT

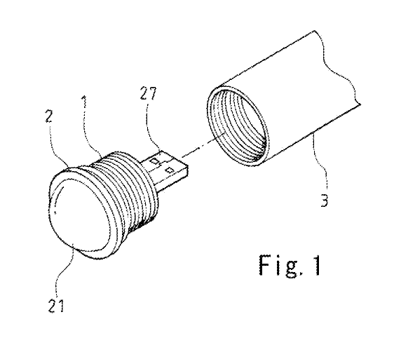

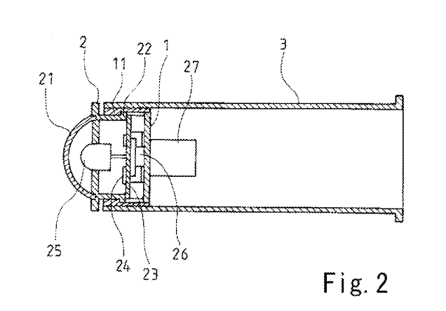

Please refer to FIGS. 1 and 2, showing respectively a pictorial breakdown drawing and a cross-sectional view of the present invention. As the figures show, the present invention includes a base body 1, a lamp holder 2, and a bar 3 connected to the base body 1. A mating part 11 is disposed on the inner edge of the wall surface of the base body 1. The lamp holder 2 caps the base body 1, with a cover body 21 disposed on its back edge and an engagement part 22 on the outer edge of its wall surface. When connected to the base body 1, the lamp holder 2 may slide along the base body 1 with the engagement and mating parts stopping it and limiting its position. A control circuit 23 and a rechargeable battery 24 are disposed on the back edge of the lamp holder 2. To one side of the control circuit 23 is electrically connected a light-emitting component 25 (a high-brightness light emitting diode in the present preferred embodiment), which is placed inside the cover body 21. To another side of the control circuit 23 is electrically connected a button 26 holding against the back edge of the base body 1 (a flexible stepless button in the present preferred embodiment), and a USB plug 27 protruding from the back edge of the base body 1. The bar 3 is hollow, with its one end locked to the base body 1 and another end caps a handle of a bicycle.

The combination of the above-mentioned elements forms a bar signal light structure. The bar 3 caps a handle of a bicycle. When riding the bicycle, a user may grip and control the bar. Before making a left or right turn, the user may press the lamp holder 2, which is caused to slide inward and press the button 26 to activate the control circuit. The control circuit 23 then turns on the light-emitting component 25 to flash as a warning, thus enhancing road safety of bicycles. When the bar signal light structure is not in use, the base body 1 may be disassembled from the bar 3 and plugged to a computer or a charger by means of its USB plug 28 for recharging the rechargeable battery 24.

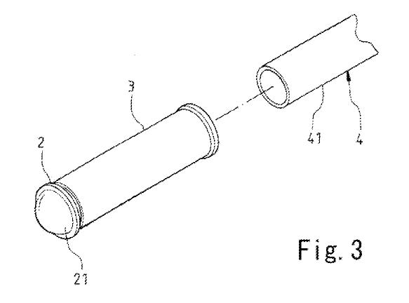

Please refer to FIG. 3, showing a view of the present invention when capping a handle of a bicycle. As the figure shows, to assemble the present invention is to have the bar 3, with the base body 1 connected to it, directly capping a handle 41 of a bicycle 4. The bar 3 and the handle 41 are closely fit, so when capping the handle 41 the bar 3 is tightly secured to the handle 41 and will not loosen up or come off easily. When riding the bicycle 4, a user may grip the bar 3 for better control.

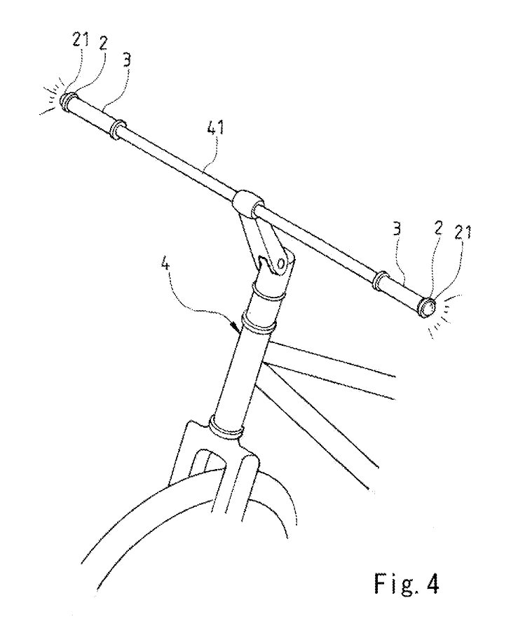

Please refer to FIG. 4, showing the present invention in use. Please refer also to FIG. 2. As these figures show, after assembling, the present invention is fixed to the handle 41 of the bicycle 4. When riding the bicycle 4, a user may grip the bar 3 and the light-emitting component 25 inside the lamp holder 2 is off. Before turning right or left, the user may press the lamp holder 2 on the left or on the right, which causes the lamp holder 2 to slide inward to press the button 26 to activate the control circuit. The control circuit 23 then turns on the light-emitting component 25 to flash as a warning to vehicles behind, thus enhancing road safety of bicycles. After making a right or left turn, the user may press the lamp holder 2 again to press the button 26, which turns off the control circuit 23 and the light-emitting component 25 is off again.

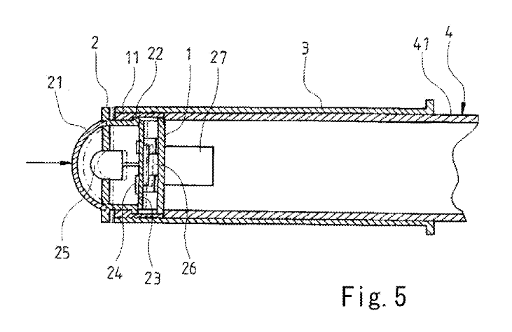

Please refer to FIG. 5, showing the present invention when activated. As the figure shows, when a user presses the lamp holder 2 of the present invention, the lamp holder 2 will slide inward along the base body 1 to press the button 26 and turn on the control circuit 23, which turns on the light-emitting component 25 to flash as a warning to vehicles behind and enhances road safety of the bicycle 4. The button 26 is a stepless one, so after the lamp holder 2 is pressed, the flexibility of the lamp holder 2 will cause it to push outward and return to its original position while the light-emitting component keeps flashing. After the bicycle 4 has made a turn, the user may press the lamp holder 2 again to cause the lamp holder 2 to slide inward again and press the button 26 to turn off the control circuit 23 and the light-emitting component 25. In like manner, after the lamp holder 2 is pressed, the flexibility of the lamp holder 2 will cause it to push outward and return to its original position, ready to be pressed again.

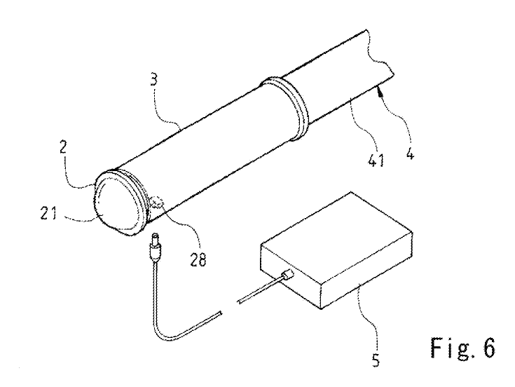

Please refer to FIG. 6, showing another preferred embodiment of the present invention. Please also refer to FIG. 2. As these figures show, on the base body 1 may be disposed a socket 28 electrically connected to the control circuit 23 for plugging a mobile electrical supply 5 (or a battery container). During a long bicycle journey, the signal light may be powered by the mobile electrical supply 5 (or the battery container).

The fore-going preferred embodiments of the present invention are illustrated of the present invention rather than limiting of the present invention. It is intended to cover various modifications and changes included within the spirit and scope of the appended claims, the scope of which should be accorded the broadest interpretation so as to encompass all such modifications and similar structures.

In view of the foregoing considerations, the present invention relates to a bar signal light structure including a base body fixed to a bar and a lamp holder disposed in the base body with a light-emitting component disposed in it. Before turning left or right while riding a bicycle, a user may press the bar to cause the light-emitting component to flash as a warning to enhance road safety of the bicycle. When not in use, the bar signal light structure may be plugged to a computer or a battery charger for recharging.

What is claimed is:

1. A bar signal light structure, comprising:
a base body fixed to the bar;
a lamp holder capping the base body, which may slide along the base body, with a control circuit and a rechargeable battery disposed on its back edge, to one side of the control circuit is electrically connected a light-emitting component, and to another side of the control circuit is electrically connected a button holding against the back edge of the base body and a USB plug protruding from the back edge of the base body;
a bar, which is hollow, with its one end locked to the base body and another end capping a handle of a bicycle; and
wherein before making a left or right turn, a user may press the lamp holder to press the button to activate the control circuit, which turns on the light-emitting component to flash as a warning; and wherein when the bar signal light structure is not in use, the base body may be disassembled from the bar and plugged to a computer or a charger by means of its USB plug for recharging the rechargeable battery.

2. The bar signal light structure of claim 1, wherein a mating part is disposed on the inner edge of the base body's wall surface and an engagement part on the outer edge of the lamp holder's wall surface so that when the lamp holder slides along the base body the engagement and mating parts may stop it and limit its position.

3. The bar signal light structure of claim 1, wherein the light-emitting component is a high-brightness light emitting diode.
